(19) United States
(12) Patent Application Publication
(10) Pub. No.: US 2015/0090475 A1
(43) Pub. Date: Apr. 2, 2015

(54) CABLES HAVING AN ANTIMICROBIAL COATING

(71) Applicant: General Cable Technologies Corporation, Highland Heights, KY (US)

(72) Inventors: Sathish Kumar Ranganathan, Indianapolis, IN (US); Jon Michael Malinoski, Zionsville, IN (US); Alben D. Roland, Providence, RI (US); Srinivas Siripurapu, Carmel, IN (US)

(21) Appl. No.: 14/563,351

(22) Filed: Dec. 8, 2014

Related U.S. Application Data
(63) Continuation-in-part of application No. 14/209,613, filed on Mar. 13, 2014.
(60) Provisional application No. 61/794,611, filed on Mar. 15, 2013.

(51) Int. Cl. H01B 7/17; H01B 19/02; A01N 43/653; H01B 19/04; A01N 59/16; A01N 31/16

(52) U.S. Cl. CPC H01B 7/17; A01N 59/16; A01N 31/16; A01N 43/653; H01B 19/04; H01B 19/02
USPC 174/113 R; 385/100; 427/58

(57) ABSTRACT

A cable having one or more conductors with a polymeric covering layer and a non-extruded coating layer formed of a material based on a liquid composition including a polymer resin and an antimicrobial additive. Methods of forming cables are also provided.

### REFERENCE TO RELATED APPLICATIONS

The present application is a continuation-in-part of U.S. patent application Ser. No. 14/209,613, filed Mar. 13, 2014, which claims priority benefit of U.S. provisional patent application Ser. No. 61/794,611, filed Mar. 15, 2013, and hereby incorporates the same applications herein by reference in their entirety.

### TECHNICAL FIELD

The present disclosure relates to cover (insulation or jacket) compositions for wires or cables having a coating thereon that enables the cable cover to reduce or prevent microorganisms or other contaminants from forming or building thereon.

### BACKGROUND

Cables, particularly those used outdoor, tend to attract and to pick up dirt and contaminants (e.g., bacteria/fungi) that adhere to or grow on the cable. That is especially true when the cable is moved frequently by being dragged on the ground or is consistently exposed to outdoor elements, such as charging cables for boats and yachts. The cable, overtime, accumulates dirt and contaminants on its outer surface, and can be difficult to keep clean to prevent growth of microorganisms without scuffing and/or destroying the surface of the covering. Scuffing of the covering can exacerbate the problem by making the cable more attractive to the buildup and growth of microorganisms.

Therefore, there remains a need for a cable that is resistant to the buildup and/or growth of microorganisms.

### SUMMARY

In accordance with one embodiment, a cable includes one or more conductors, a polymeric covering layer and a non-extruded coating layer. The non-extruded coating layer is formed from a liquid composition. The liquid composition includes a polymer resin and an antimicrobial additive.

In accordance with another embodiment, a method of reducing the growth of microorganisms on a surface of a cable includes providing one or more conductors each covered with a polymeric covering layer, coating an outer surface of the polymeric covering layer with a liquid composition, and drying the liquid composition. The liquid composition includes a polymer resin and an antimicrobial additive.

### BRIEF DESCRIPTION OF THE DRAWINGS

FIG. 1 is a cross-section of one embodiment of a cable the present disclosure.

FIG. 2 is a cross-section of another embodiment of a cable of the present disclosure.

### DETAILED DESCRIPTION

The present disclosure provides a cable that is resistant to dirt and contaminants (e.g., bacteria or fungi) and is capable of being easily cleaned without damaging the cable covering. The present disclosure provides a cable including one or more conductors (or a cabled core), a covering (jacket or insulation), and a coating layer surrounding the covering. The coating layer can be formed from a material based on a liquid composition. The liquid composition can include a polymer resin and an antimicrobial additive. The liquid composition can also include a fatty acid amide in certain embodiments. Suitable polymer resins can include a urethane composition or an epoxy composition. The coating layer can be a non-extruded layer, because the liquid composition may not be amenable to extrusion due to its low viscosity. Cables described herein can have diameters from about 6 mm to about 40 mm.

To form such cables, each of the one or more conductors can first be covered with a covering layer made of polymeric material. The covering layer can generally be used in the art as a cable jacket and/or an insulation layer. The covering layer can then be coated, particularly on its outer surface, with a coating layer made of a liquid composition as described herein.

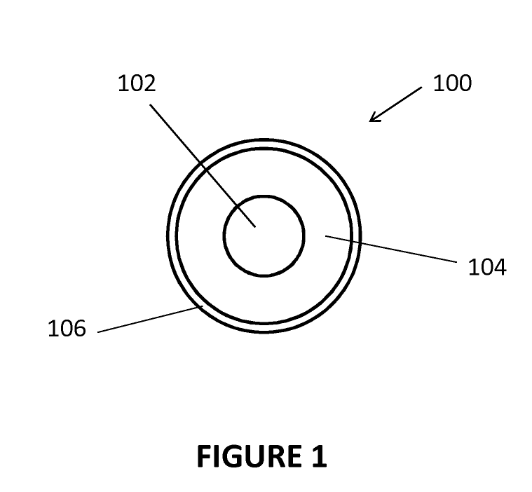

FIG. 1 shows one embodiment of a cable of the present disclosure. As illustrated in FIG. 1, a cable 100 can include a conductor 102, an insulation 104 covering the conductor 102, and a coating layer 106. The coating layer 106 can contain an antimicrobial additive that can reduce or prevent the growth or spread of unwanted contaminants, such as bacterial or fungal elements, providing an antimicrobial effect. The coating layer 106 can allow the cable 100 to be cleaned without damaging the insulation 104. In certain embodiments the coating layer 106 can include a fatty acid amide which can further assist in reducing or preventing buildup of dirt or other damaging components.

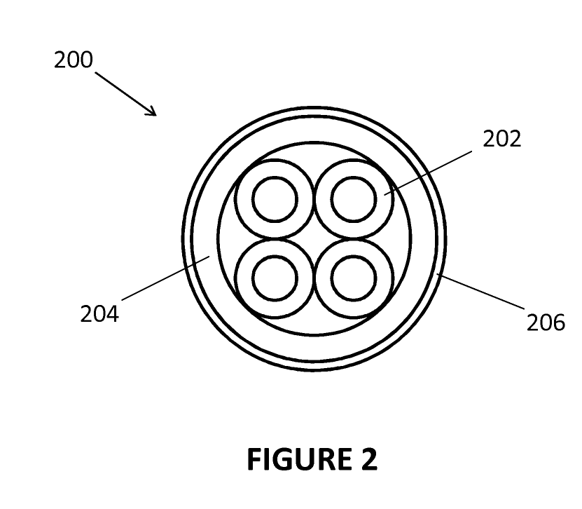

As shown in FIG. 2, a cable 200 can include a plurality of insulated conductors 202 which can be covered by a jacket 204. The outer surface of the jacket 204 can be coated with a coating layer 206. The coating layer 206 can contain an antimicrobial additive that can reduce or prevent the growth or spread of unwanted contaminants, such as bacterial or fungal elements, providing an antimicrobial effect. The coating layer 206 can allow cable 200 to be cleaned without damaging the jacket 204. In certain embodiments the coating layer 206 can include a fatty acid amide which can further assist in reducing or preventing buildup of dirt or other damaging components.

In certain embodiments, a conductor can be an optical conductor or an electrical conductor. The optical conductor can include an optical fiber conductor. The electrical conductor can include a copper or aluminum conductor.

A covering layer for a cable can be any insulation or jacket generally used in the art. The covering layer can have a polymer base that can be a rubber or a polyolefin. Suitable polyolefins can include polyethylene (such as low-density (LDPE), high-density, high molecular weight (HDPE), ultra-high molecular weight (UHDPE), linear-low-density (LLDPE), very-low density, etc.), maleated polypropylene, polypropylene, polybutylene, polyhexalene, polyoctene, and copolymers thereof, and ethylene-vinyl-acetate (EVA) copolymer, and mixtures, blends or alloys thereof. Covering polymers can also include thermoplastic elastomers (TPE), neoprenes, chlorinated polyethylenes (CPE), ethylene-propylene-diene ter-polymer (EPDM), nitrile butadiene rubber/polyvinyl chloride (NBR/PVC), or combinations thereof. Examples of compositions for example covering layers can include those as follows:

### 1) For CPE

| | |
|---|---|
| Polymer | 100 parts |
| Plasticizer | 40 parts |
| Mineral Fillers | 50 parts |
| Cure package | 5 parts |
| Other (flame retardants, co-agents, process aids, color) | 30 parts |

### 2) For EPDM

| | |
|---|---|
| Polymer | 100 parts |
| Plasticizer | 70 parts |
| Mineral Fillers | 100 parts |
| Cure package | 5 parts |
| Other (co-agents, process aids, color) | 25 parts |

### 3) For NBR/PVC

| | |
|---|---|
| Polymer | 100 parts |
| Plasticizer | 20 parts |
| Mineral Fillers | 60 parts |
| Cure package | 5 parts |
| Other (flame retardants, process aids, color) | 50 parts |

### 4) For Neoprene

| | |
|---|---|
| Polymer | 100 parts |
| Plasticizer | 15 parts |
| Mineral Fillers | 80 parts |
| Cure package | 5 part |
| Other (flame retardants, process aids, color) | 50 parts |

In addition to the base polymer, the covering layer can include other additives, including but not limited to, flame retardants, fillers, antioxidants, processing aids, colorants, and stabilizers.

Coating layers can be formed of a material based on liquid composition. Such liquid compositions can include a polymer resin, antimicrobial additive and optionally a primary or secondary fatty acid amide. Because a liquid composition can have a relatively low viscosity, the coating layer can be non-extruded. Suitable examples of processes of applying such coating layers include painting, spraying, or dipping as detailed below. In certain embodiments, a coating layer formed from a liquid composition can include a polymer resin, antimicrobial additive, optionally a fatty acid amide, and a solvent. In certain embodiments, a liquid composition can have about 5% or less by weight of an antimicrobial additive; and in certain embodiments from about 0.1% to about 2% by weight of an antimicrobial additive. In certain embodiments, a liquid composition can have about 5% or less of a fatty acid amide; and in certain embodiments, from about 0.5% to about 5% by weight of a fatty acid amide. The antimicrobial additive and optional fatty acid amide can be dispersed in the resin and solvent, e.g. using techniques known in the art. Such solvents can include a mixture or a single solvent. Suitable solvents can include water and/or N-methyl pyrrolidone, with a water-based emulsion system. It will be appreciated that certain liquid compositions can be substantially solvent-free. Liquid compositions can also include other components, including, for example dispersants, anti-settling aids, wetting agents, UV stabilizers, heat stabilizers, surfactants, and/or combinations thereof. In certain embodiments, when the liquid composition includes a solvent, the solid content of a liquid composition can be about 25% to about 60% (by weight of the liquid composition); in certain embodiments, from about 30% to about 55%; and in certain embodiments from about 35% to about 50%. In certain embodiments, where the liquid composition is substantially solvent-free, the total solid content of the liquid composition can be up to 100%.

In certain embodiments, a polymer resin can be an epoxy, urethane, acrylic, fluoropolymer, silicone, and copolymers thereof. These resins could be in the form of emulsion, dispersion or suspension. In certain embodiments, a polymer resin can be a urethane liquid composition, and in certain embodiments a water-based urethane composition. Such urethane compositions can include single to two part urethane compositions. Single part compositions can be easy to use. Two part systems can generally include a first part that includes the urethane resin and a second part that includes a curing agent. When the two parts are mixed, the composition can be cured to form a thermoset. The single part systems can be easier to use because no mixing of ingredients is needed. The composition can simply be applied without any premixing or preparation. In one example, a coating layer can be based on a single part, water-based urethane resin.

Liquid compositions used to form such coating layers described herein having antimicrobial additives can include a variety of types of such additives. Generally, the term “antimicrobial” can be understood to mean an agent which inhibits the growth or prevents the proliferation of microorganisms. Microorganisms comprise bacteria, viruses, protozoa and fungi, including yeasts and molds. The term “antimicrobial” thus encompasses the terms “antibacterial”, “antifungal” and “antiviral”. Analogously, the expression “microbiocidal compound” represents an agent which destroys or kills microorganisms. The expression “microbiocidal compound” encompasses, inter alia, bactericidal and fungicidal compounds.

In certain embodiments antimicrobial additives can include metal compounds or non-metal compounds.

Suitable examples of antimicrobial additives that are metal compounds include silver ion based compounds (e.g., nano silver, micro silver and silver-zeolites); other metals and metal oxides (e.g., copper, zinc, mercury, antimony, lead, bismuth, cadmium, chromium, and thallium); zinc pyrithione; omadine zinc pyrithione; sodium pyrithione; silver sulfadiazine; tributyltin compounds and metal complexes of Co, Ni and Zn with 2-(1′-hydroxynaphthyl)benzoxazoles. In certain embodiments metal compounds can function as an antibacterial additive.

Suitable examples of antimicrobial additives that are non-metal compounds include alkyl aryl benzalkonium chloride, resinous triclosan, chlorohexidine gluconate, parachlorometaxylenol (PCMX), benzylthoneium chloride, chitosan pyrrolidone carboxylate, hexaconazole (2-(2,4-Dichlorophenyl)-1-(1H-1,2,4-triazol-1-yl)hexan-2-ol), (5-chloro-2-(2,4-dichlorophenoxy)phenol), methyl (benzimidazole-2-yl) carbamate, di-iodomethyl para tolyl sulfone, 2-thiazo lyl 1H-benzimindazole, isothiazolone, 4,5 -dichloro-2octyl 1,10,10 BIS (phenoxyl/arsinyl) oxide, 4,5 -dichloro-2-n-octyl-4-isothiazo lin-3-one, 10,10′oxybisphenoxarsine (OBPA), 1-chloro-3-alkyl-5,5-dimethylhydantoins and N-halamine. In certain embodiments non-metal compounds can function as an antifungal additive.

Other non-limiting examples of antimicrobial additives include 3,5-dimethyl-tetrahydro-1,3,5-2H-thiodiazin-2-thione, bis-tributyltinoxide, N-butyl-benzisothiazoline, zinc-2-pyridinthiol-1-oxide, 2-methylthio-4-cydopropylamino-6-(α,β-dimethylpropylamino)-s-triazine, 2-methylthio-4-cyclopropylamino-6-tert-butylamino-s-triazine, 2-methylthio-4-ethylamino-6-(α,β-dimethylpropylamino)-s-triazine, 2,4,4′-trichloro-2′-hydroxydiphenyl ether, IPBC, carbendazim, thiabendazole, 2-phenyl phenol, 4,4′-dichlor-2-hydroxydiphenylether, 2,2′-methylenbis-(4-chloro-phenol), 4-(2-t-butyl-5-methylphenoxy)-phenol, 3-(4-chlorophenyl)-1-(3,4-dichloro-phenyl)-urea and 2,4,6-trichlorophenol.

In addition to the polymer resin and antimicrobial additive, the liquid composition can also include a fatty acid amide, including primary and secondary fatty acid amides. A fatty acid amide can include molecules where the fatty group of the fatty acids is C11 to C21 alkyl or alkenyl. Examples of suitable fatty acid amides can include, but are not limited to, oleamide, erucamide, stearamide, behenamide, oleyl palmitamide, stearyl erucamide, ethylene-bis-stearamide, or ethylene-bis-oleamide. In one embodiment, a fatty acid amide can be ethylene-bis-stearamide.

Covering layers described herein can be applied onto a cable using methods generally known in the art. A covering layer can be extruded onto a bare conductor to form an insulation layer, or onto at least one insulated conductor to form a jacket. Extrusion methods for applying the covering layer are well-known in the art.

The coating layer formed from a liquid composition can be applied to the outer surface of a covering layer, either directly or after the surface has been prepared. Preparation may include cleaning the outer surface of the covering or treating that surface to improve the adhesion of the coating. The preparation can be as simple as cleaning with soap and water to corona treatment or flame treatment. A covering layer can be wiped with isopropyl alcohol, dried, and heated. In certain embodiments, the heating can take place in an oven heated to about 90° C. to about 200° C. for about 1 second to about 1 minute; in certain embodiments about 2 seconds to about 30 seconds; and in certain embodiments about 3 seconds to about 10 seconds.

In certain embodiments, a liquid composition for the coating layer can be applied by spraying. A spray gun can be used with 10-45 psi pressure, and controlled through air pressure. The spray gun nozzle can be placed at opposite direction of the conductor (at approximately 90° angle) to get a uniform coating on conductor product. In certain cases, two or more guns can be used to get more efficient coatings. The coating thickness can be controlled by the admixture viscosity, gun pressure, and conductor line speed. During the coating application, the temperature can be maintained at about room temperature depending on the material of the covering and/or of the coating.

Alternatively, the coating layer can be applied to the covering layer of a cable by dipping or painting. Here, the covered cable can be dipped into the liquid coating mixture to allow the mixture to completely coat the conductor. The cable can then be removed from the coating mixture and cured/dried. In painting, the liquid coating mixture can be painted on to the outer surface of the covering layer using a brush or a roller.

After application, in certain embodiments, a coating layer can be dried/cured either at room temperature or at elevated temperatures at about 320° C. or less, in certain embodiments from about 80° C. to about 220° C., and in certain embodiments from about 90° C. to about 150° C., for about 10 seconds to about 60 minutes, in certain embodiments from about 10 seconds to about 15 minutes, and in certain embodiments from about 10 seconds to about 3 minutes. Curing/drying can occur on-line in the production process and/or off-line. In certain embodiments, on-line curing/drying is sufficient to achieve a tack-free coating. In certain embodiments, such drying can occur at temperatures from about room temperature to about 100° C. and the time for drying can occur at about 1 minute or less. Curing and/or drying can be accomplished using a variety of methods, including for example UV treatment, chemical treatment or other suitable methods.

The coating process can be automated with robotic systems. The automated process can function in three steps: 1) preparing the outer surface of the covering layer; 2) applying the coating layer on the outer surface of the covering layer; and 3) curing the coating layer. The coating process can be batch, semi-batch, or continuous, with continuous being especially effective for automation. The line speed of the continuous coating process can be from about 10 feet/minute to about 750 feet/minute in certain embodiments, in certain embodiments from about 300 feet/minute to about 600 feet/minute, and in certain embodiments from about 400 feet/minute to about 500 feet/minute.

Once completely dried/cured, a coating layer can have a thickness of about 2 mils or less in certain embodiments, in certain embodiments about 1 mil or less, and in certain embodiments about 0.5 mil or less. The dried/cured coating layer can also contain about 15% or less of fatty acid amide (by weight of the dried/cured coating) in certain embodiments, in certain embodiments from about 2% to about 15%, and in certain embodiments from about 5% to about 15%. That concentration can be much higher than that of the liquid coating composition due to evaporation of the volatile components during the drying/curing process.

As noted above, a coating layer can help to reduce or prevent the growth of microorganisms in certain embodiments; and in certain embodiments, a coating layer can allow the cable to be easily cleaned without damaging the covering layer. Thus, a coating layer can also render the cable more resistant to dirt and contamination. It will further be appreciated that cables described herein can sustain water aging, heat aging, low temperature impact, flexibility, and exterior weather conditions.

Without further description, it is believed that one of ordinary skill in the art can, using the preceding description and the following illustrative example, make and utilize the compounds of the present disclosure and practice the claimed methods. The following example is given to illustrate the present disclosure. It should be understood that the disclosure is not to be limited to the specific conditions or details described in this example.

### EXAMPLES

Wire samples (16AWG Wire PE 31.13.000605) were used in the testing with different coating layers formed from liquid compositions.

Coating Procedure: A 10″ portion of wire was heated for 2 minutes at about 230° C., and then coating layer was applied by wiping with a sponge brush.

Drying Procedure: A heat gun was applied for 2 minutes until sample was dry and not tacky.

Coating quality check: Manual bend over a mandrel having the same size as the diameter of the cable. There must be no cracking or delamination for the cable to be tested.

### Test Procedures

To determine the antimicrobial effectiveness of a coating layer having an antimicrobial additive a variety of antimicrobial tests can be used, for example the Antibacterial Test (ASTM E 2180) and the Anti-Fungal Test (ASTM G 21). Other tests for evaluating the cleanliness of the outer surface of the cable can also be utilized, including, for example, a color test which can determine a color value of the outer surface of the cable to determine how effectively clean it is.

In one example, a cable was dipped into a tray containing simulated dirt composition containing N660 carbon black, and the cable was then rolled to coat all sides. The cable is then removed from the tray and the excess simulated dirt is shaken off. The sample is then allowed to rest for 10 minutes before cleaning. The cleaning procedure involved rinsing the sample cable under running water for 1 min, followed by a soap and water wash. Color value of the samples were measured before and after washing. Examples of how effective certain coating layer compositions can be in providing an easy way to clean the outer surfaces of cables are further provided in U.S. patent application Ser. No. 14/209,613, which is hereby incorporated by reference herein.

In the examples below the ASTM G 21 Antibacterial Test was performed on a number of sample cables to determine how well the outer surface of a cable prevented the growth of microorganisms. Pursuant to ASTM G 21 a rating of 0 represents no antibacterial growth, a rating of 1 represents trace growth (less than 10%), a rating of 2 represents light growth (from 10% to 30%), a rating of 3 represents medium growth (30% to 60%) and a rating of 4 represents heavy growth (60% to 100%). To be effective in reducing the amount of growth of a bacteria, a rating of 0, 1, or 2 is acceptable. As illustrated below in Table 1, various amounts of antibacterial and/or antifungal additives were included in Inventive Examples 3-8 and each of these cables illustrated either no growth or little growth pursuant to ASTM G 21. As illustrated, Comparative Examples 1 and 2 illustrated medium growth. Further, Inventive Examples 3-5, and 7-8 further illustrated a reduction in the amount of certain bacteria, including either Pseudomonas aeruginosa and/or S. Aureus.

TABLE 1

| | Comparative | | | | | | | |
|---|---|---|---|---|---|---|---|---|
| | Example 1 | | | | | | | |
| | (Uncoated | Comparative | Inventive | Inventive | Inventive | Inventive | Inventive | Inventive |
| Liquid Composition | Cable) | Example 2 | Example 3 | Example 4 | Example 5 | Example 6 | Example 7 | Example 8 |
| Urethane water-based (35 wt. | | 100% | 99.9% | 99.8% | 98% | 99.8% | 98% | 99.6% |
| %) | | | | | | | | |
| Antibacterial additive | | | 0.1% | 0.2% | 2% | | | 0.2% |
| (silver) | | | | | | | | |
| Antifungal additive | | | | | | 0.2% | 2% | 0.2% |
| (organic powder) | | | | | | | | |
| Properties | | | | | | | | |
| Anti-fungal test (ASTM | 3 | 3 | 2 | 2 | 0 | 1 | 0 | 0 |
| G21)-after four weeks | | | | | | | | |
| (rating) | | | | | | | | |
| Pseudomonas. Aeruginosa | | | 64.74 | 65 | — | — | 8.4 | 63.8 |
| reduction (%) | | | | | | | | |
| S. Aureus reduction (%) | | | 48 | 30.6 | 8.08 | — | 22.42 | 38.2 |

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of ordinary skill in the art. Rather it is hereby intended the scope be defined by the claims appended various embodiments. The scope is, of course, not limited to the examples or embodiments set forth herein, but can be employed in any number of applications and equivalent articles by those of hereto.

What is claimed is:

1. A cable comprising:
one or more conductors;
a polymeric covering layer; and
a non-extruded coating layer formed from a liquid composition, the liquid composition comprising a polymer resin and an antimicrobial additive.

2. The cable of claim 1, wherein the antimicrobial additive comprises at least one metal compound and at least one non-metal compound.

3. The cable of claim 2, wherein the at least one metal compound comprises a silver-based compound.

4. The cable of claim 2, wherein the at least one non-metal compound comprises one or more of triclosan and hexaconazole.

5. The cable of claim 1, wherein the polymeric covering layer is extruded.

6. The cable of claim 1, wherein the antimicrobial additive comprises about 1% or less by weight of the liquid composition.

7. The cable of claim 1, wherein the one or more conductors comprise an optical conductor or an electrical conductor.

8. The cable of claim 1, wherein the polymeric covering layer comprises polyethylene, low-density polyethylene, high-density polyethylene, high molecular weight polyethylene, ultra-high molecular weight polyethylene, linear-low-density polyethylene, very-low density polyethylene, maleated polypropylene, polypropylene, polybutylene, polyhexalene, polyoctene, ethylene-vinyl-acetate copolymer, thermoplastic elastomers, neoprenes, chlorinated polyethylenes, ethylene-propylene-diene ter-polymer, nitrile butadiene rubber/polyvinyl chloride, copolymers thereof, or combinations thereof.

9. The cable of claim 1, wherein the polymer resin comprises one of an epoxy or a urethane.

10. The cable of claim 1, wherein the non-extruded coating layer has a thickness of about 5 mils or less.

11. The cable of claim 1, wherein the polymeric covering layer is an insulation layer or a jacket layer for the cable.

12. The cable of claim 1, wherein the polymeric covering layer is cross-linked.

13. The cable of claim 1, wherein the polymeric covering layer surrounds the one or more conductors.

14. The cable of claim 1, wherein the non-extruded coating layer is applied to an outer surface of the polymeric covering layer.

15. The cable of claim 1, wherein the liquid composition further comprises water.

16. A method of reducing the growth of microorganisms on a surface of a cable, the method comprising:
a. providing one or more conductors each covered with a polymeric covering layer;
b. coating an outer surface of the polymeric covering layer with a liquid composition, the liquid composition comprising a polymer resin and an antimicrobial additive; and
c. drying the liquid composition.

17. The method of claim 16, wherein the coating of the outer surface of the polymeric covering layer comprises one or more of spraying, dipping, and painting.

18. The method of claim 16, wherein the coating of the outer surface of the polymeric covering layer occurs at room temperature.

19. The method of claim 16, wherein prior to coating the outer surface of the polymeric covering layer, the outer surface of the polymeric covering layer is cleaned and dried.

20. The method of claim 16, wherein drying of the liquid composition occurs at a temperature from about 80° C. to about 220° C.
